(19) United States
(12) Patent Application Publication
(10) Pub. No.: US 2018/0126813 A1
(43) Pub. Date: May 10, 2018

(54) AMPHIBIOUS VEHICLE

(71) Applicant: Young Chan PARK, Seongnam-si (KR)

(72) Inventor: Young Chan PARK, Seongnam-si (KR)

(21) Appl. No.: 15/717,896

(22) Filed: Sep. 27, 2017

(30) Foreign Application Priority Data
Nov. 10, 2016 (KR) 10-2016-0149199

(51) Int. Cl. B60F 3/00

(52) U.S. Cl. CPC B60F 3/0038; B60F 3/0069; B60F 3/0007

(57) ABSTRACT

An amphibious vehicle that travels in water by controlling a manipulating panel installed in a vehicle body in the case where the vehicle body enters water from land or from water to land is disclosed. The amphibious vehicle includes a pair of piston propellants mounted to a rear bumper of a vehicle body, a lift wing floating body mounted between a front wheel and a rear wheel inside the vehicle body, a secondary piston propellant which adjusts a moving direction with a proceeding direction and a brake direction of the vehicle body, and a manipulating panel positioned inside the vehicle body and mounted on a bottom surface of a front bumper of the vehicle body.

### CROSS-REFERENCE TO RELATED APPLICATION

This application claims priority to Korean Patent Application No. 10-2016-0149199 filed on Nov. 10, 2016, and all the benefits accruing therefrom under 35 U.S.C. § 119, the content of which is incorporated by reference in its entirety.

### BACKGROUND

The present invention relates to an amphibious vehicle, which is capable of being converted from on-ground to on-water movement, in a manner of putting down a lift wing floating body which is detachably provided on a lower surface of the vehicle, and of changing direction of a horizontal oil tank tail which is a steering key, upon operation on water, and of driving a vertical floating body for rescue and a piston propulsion apparatus.

In general, an amphibious vehicle refers to a vehicle which is provided with wheels or a caterpillar for traveling on land, and a structure for cruising on water (i.e., a structure having buoyancy and propelled by propellers or web plates).

In Korean Patent Application Publication No. 2010-0087535 (Aug. 5, 2010), a simplified amphibious vehicle using a rubber boat, which is allowed to be movable on land as well as on water, such as a river, sea and the like, in a manner of using the rubber boat which is detachably provided on a lower surface of the vehicle, is disclosed.

However, in such prior art, there is an inconvenience in that, a user (driver) must attach the rubber boat on the lower of the vehicle for the user to use the vehicle on water and must detach the rubber boat to use the vehicle on land again.

To overcome such inconvenience, Korean Patent Application Publication No. 2010-0133520 (Dec. 22, 2010) discloses an amphibious vehicle which has a pair of propellers installed on a lower surface of the amphibious vehicle to be capable of moving at a faster speed in water, is capable of a 360° rotation to the left/right in a stopped state to improve the rotation capacity of the amphibious vehicle, and enables moving the vehicle backwards at a fast speed when backing, ensuing mobility of the amphibious vehicle. However, in such prior art, the height of a propulsion apparatus accommodating a propeller is fixed, and accordingly, a cavitation is generated in the water when water is rotated. The cavitation frequently cases damages on the propellers. Here, the cavitation phenomenon refers to a phenomenon of a pressure of a liquid becoming lower than the atmospheric pressure of the liquid at a specific point when the liquid is flowing, separating the air inside the liquid and vapor to form air bubbles and a vacuum.

Consequently, it is required to develop a simplified vehicle body 100 for rescuing, which the general public can easily mount under situations where water damages are frequently caused due to regional torrential rains that are frequently resulted from global warming.

### SUMMARY

To overcome the drawbacks of the prior art, an aspect of the detailed description is to provide an amphibious vehicle, capable of being applied to vehicles which are currently being produced or sold, in a very convenient manner at a low price.

Another aspect of the detailed description is to provide an amphibious vehicle capable of extending the lifespan of vehicle components by avoiding an occurrence of cavitation while the vehicle is driven on water, in a manner of installing a pair of piston propellants at a rear bumper of the vehicle.

An amphibious vehicle according to a preferred embodiment disclosed herein may include a pair of piston propellants 200 and 300 mounted to a rear bumper 120 of a vehicle body 100, operated in an alternating motion with respect to each other so as to push back water of a water surface while a scotch yoke motor 210 is converted to a reciprocating motion to move in a direction from an upper part to a lower part upon rotation in a left or right direction; a lift wing floating body 400 mounted between a front wheel 150 and a rear wheel 160 of the vehicle body 100 inside the vehicle body 100, which is extended in a front bumper 110 and a rear bumper 120 direction to cover the front wheel 150 and the rear wheel 160; a secondary piston propellant 800 which adjusts a moving direction with a proceeding direction and a brake direction of the vehicle body 100 according to a control of a user; and a manipulating panel 900 positioned inside the vehicle body 100 and mounted on a bottom surface of the front bumper 110 of the vehicle body 100, which selectively controls an operation of a front wing rod circular coil 700 extended to a front direction according to a manipulation of the user.

An amphibious vehicle according to the present disclosure described above may have the following effects.

An amphibious vehicle according to the present disclosure may have a simple structure to enable convenient application to on-land vehicles which are currently produced or on sale, and can be implemented with low installation costs and without a user having to attach or detach additional components or equipment.

Further, according to the present disclosure, even if a vehicle falls into or crashes in from land to water, not only can it easily travel on the water as a rescue vehicle, but a driver may also drive the vehicle to the water from the land for leisure purposes.

In addition, in a case where a vehicle is driven on water, because a pair of piston propellants of a rear bumper of the vehicle is installed, cavitation does not occur, thereby extending the lifespan of vehicle components.

Further, since the present disclosure does not use propellers installed on general amphibious vehicles, frequent breakdown or replacement of components may be minimized to allow reduction in maintenance costs of the vehicle.

### BRIEF DESCRIPTION OF THE DRAWINGS

FIG. 1 is a schematic view illustrating an overall form of an amphibious vehicle according to a preferred embodiment of the present invention.

FIG. 2 is a view illustrating a configuration of a connecting rod of a piston propellant of an amphibious vehicle according to a preferred embodiment of the present invention.

FIG. 3A and FIG. 3B are views for describing an operation of a lift wing floating body of an amphibious vehicle according to a preferred embodiment of the present invention.

FIGS. 4A, 4B, and 4C are views for describing an operation of a lift wing of an amphibious vehicle according to a preferred embodiment of the present invention.

FIG. 5 is a view for describing an operation of a horizontal oil tank tail which is a steering key of an amphibious vehicle according to a preferred embodiment of the present invention.

FIG. 6 is a view illustrating a structure and principle of operation of a diving control key (oil pump piston) of an amphibious vehicle according to a preferred embodiment of the present invention.

FIG. 7 is a view for describing an operation of converting a turbulent flow into a laminar flow of a front wing rod circular coil of an amphibious vehicle according to a preferred embodiment of the present invention.

FIG. 8 is a view for describing an operation of a secondary piston propellant of an amphibious vehicle according to a preferred embodiment of the present invention.

### DETAILED DESCRIPTION

Hereinafter, an exemplary embodiment of the present invention will be described in detail with reference to accompanying drawings.

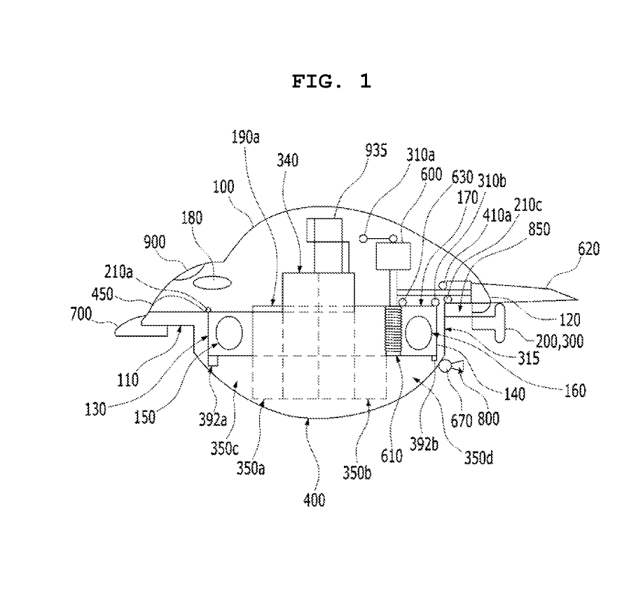

FIG. 1 is a schematic view illustrating an overall form of an amphibious vehicle according to a preferred embodiment of the present invention.

An amphibious vehicle according to a preferred embodiment of the present disclosure is configured to have a vehicle body 100, a pair of piston propellants 200 and 300, a lift wing floating body 400, a secondary piston propellant 800, and a manipulating panel 900.

Here, a pair of piston propellants 200 and 300 are mounted on a rear bumper 120 of the vehicle body 100, and are operated in an alternating motion with respect to each other so as to push back water of a water surface while a scotch yoke motor 210 is converted to a reciprocating motion to move in a direction from an upper part to a lower part upon rotation in a direction to one side. That is, when a scotch yoke motor 210 is rotated to one side, locker arms 280a and 280b and crankshafts 270a, 270b, 270c and 270d move in a reciprocating motion, and crankshafts 270a, 270b, 270c and 270d rotate 180 degrees to enable the piston propellants 200 and 300 to move linearly from bottom to top and top to bottom. As a principle of operation for the piston propellants to move in a reciprocating motion, when a motor is driven in a rotating motion, a rotary circular plate 220 is rotated with a driving shaft through a belt 260, and consequently the rotating motion of the motor is converted to a reciprocating motion.

Further, the lift wing floating body 400 is mounted between a front wheel 150 and a rear wheel 160 of the vehicle body 100 positioned at a bottom floor of a side sill panel of a vehicle body 100, inside the vehicle body 100, which is extended in a front bumper 110 and a rear bumper 120 direction to cover the front wheel 150 and the rear wheel 160 of the vehicle body.

Further, a secondary piston propellant 800 is mounted at a lower end of a secondary rear bumper 140 positioned between the pair of piston propellants 200 and 300, and adjusts a moving direction with a proceeding direction and a brake direction of the vehicle body 100 according to a control of a user.

Further, a manipulating panel 900 is positioned inside the vehicle body 100 and mounted at a bottom surface of the front bumper 110 of the vehicle body 100, which selectively controls an operation of a front wing rod circular coil 700 extended to a front direction according to a manipulation of the user.

Referring to FIG. 1, upon the entry of the vehicle body 100 from land to water, when a double acting hydraulic cylinder (a hydraulic cylinder having a structure enabling the provision of oil pressure to both sides of a piston) is pushed from top to bottom, the lift wing floating body 400 which is positioned inside the vehicle body 100 is put down, and at the same time, secondary lift wing floating bodies 350a and 350b are spread from the inside of the lift wing floating body to a left-right horizontal direction and extended and mounted to the bottom floor of the front wheel 150 and rear wheel 160, and the lift wing floating body 400 checks a first underwater electric motor 210a positioned inside the vehicle body and enters the water.

To prevent twisting and bending in a front-rear direction and left-right direction, the lift wing floating body 400 and the horizontally extended secondary lift wing floating body 350a and 350b extend the bottom surface of a secondary front bumper 130 and the bottom surface of a secondary rear bumper 140 to fix the lift wing floating body 400 therebetween. Permanent magnets 392a, 392b are attached at an end portion of the left and right sides of the bottom surface of the secondary lift wing floating bodies 350a and 350b, extending vertically from the secondary front bumper 130 and secondary rear bumper 140 to the bottom surface, and an electromagnet is attached at the extended bottom surface of the secondary front bumper 130 and the bottom surface portion of the secondary rear bumper 140. When an electric current is applied to the secondary front bumper and the secondary rear bumper, the electromagnet is actuated to be attached together with the bottom surface left and right side end portion permanent magnets 392a and 392b of the secondary lift wing floating body so twisting in the front and rear direction and right and left direction of the secondary lift wing floating bodies 350a and 350b is prevented.

Further, in the water, the piston propellants 200 and 300 and a secondary piston propellant 800 mounted at the bottom surface of the secondary rear bumper 140 is manipulated to operate the vehicle body. Upon entering land from the water, the lift wing floating body 400 is mounted while spreading in a drawer type sliding manner in the left and right direction, and at this time, as the lift wing floating body 400 is folded to the center and collected, due to a double acting hydraulic cylinder the lift wing floating body 400 is inserted at the bottom floor of the vehicle body into the vehicle body, thereby allowing the vehicle to freely move on the land.

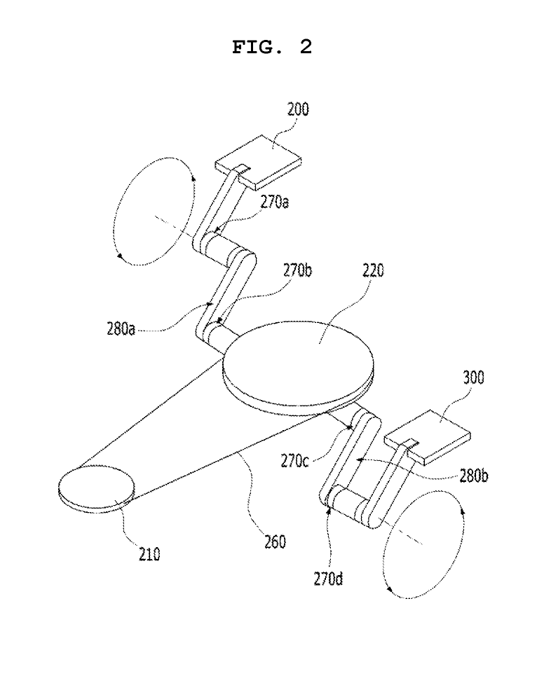

Here, as shown in FIG. 2, the pair of piston propellants 200 and 300 include a connecting rod (a rod for connecting a piston and a crank shaft pin).

The pair of piston propellants 200 and 300 are mounted at a bottom surface of the rear bumper 120 of the vehicle body, and are operated in an alternating motion with respect to each other so as to push back water of a water surface while a scotch yoke motor 210 is converted to a reciprocating motion to move in a direction from an upper part to a lower part upon a rotating motion in a direction to one side. The rotating motion of the pair of piston propellants is converted to a reciprocating motion due to the scotch yoke that generates a predetermined driving force according to the control of the manipulating panel 900 installed inside the vehicle body, and as the scotch yoke motor 210 is rotated to one side, locker arms 280a and 280b and crankshafts 270a, 270b, 270c and 270d move in a reciprocating motion, and crankshafts 270a, 270b, 270c and 270d rotate 180 degrees to enable the piston propellants 200 and 300 to move linearly from bottom to top and top to bottom. As a principle of operation for the piston propellants 200 and 300 to move in a reciprocating motion, when a motor is driven in a rotating motion, a rotary circular plate 220 is rotated with a driving shaft through a belt 260, and consequently the rotating motion of the motor is converted to a reciprocating motion. The crank shaft and cylinder are connected to each other, and the scotch yoke motor 210 is driven using the crankshaft and the piston rotary circular plate 220 and belt 260. The first and second crankshafts 270a, 270b, 270c and 270d move in a rotating motion in a specific direction by the drive of the scotch yoke motor 210.

The first and second piston propellants are connected and fixed to a first and second connecting rod (a rod for connecting a piston and a crankshaft pin) respectively, to form a linear motion path of the first and second piston that executes a linear reciprocating motion.

The crankshafts 270a, 270b, 270c and 270d and the scotch yoke motor 210 connected to the rotary circular plate 220 with the belt 260 are operated to fix a central portion and rear portion of the first and second piston propellants 200 and 300, by being hung to two mechanical wheels so as to deliver a supply power of one shaft to another shaft.

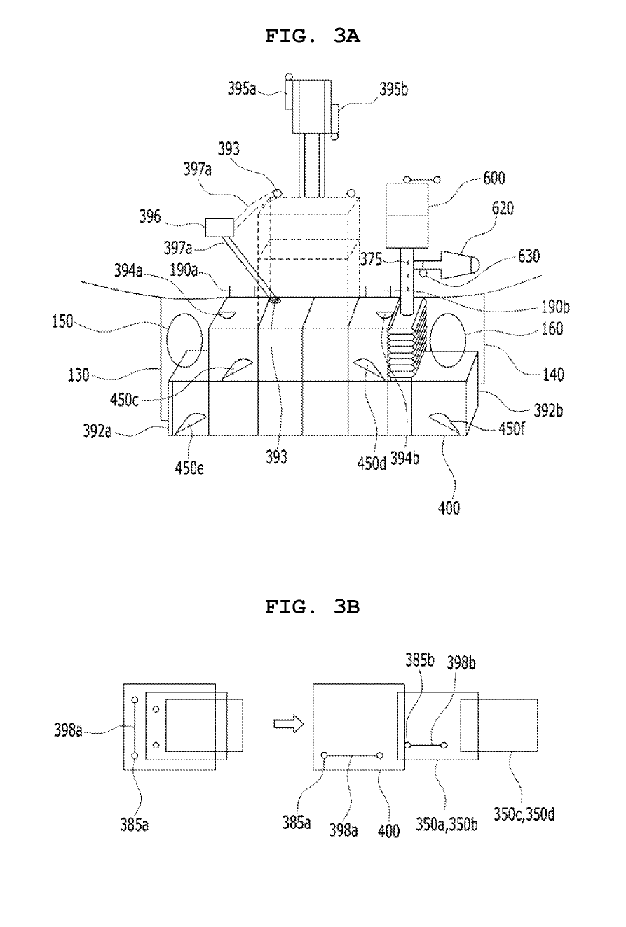

Further, as shown in FIGS. 3A and 3B, the lift wing floating body 400 is configured to have a main lift wing floating body 400a wherein double acting hydraulic cylinders 395a and 395b that generate a predetermined driving force according to the control of the manipulating panel 900 in a state mounted inside the side sill panel 170 of the vehicle body 100 are extended to a predetermined length from top to bottom, and secondary lift wing floating bodies 350a and 350b installed inside the main lift wing floating body 400a and which extends in a horizontal direction to a predetermined distance by the drive of drawer type sliding supports 398a and 398b and a motor 310a.

Here, the side sill panel 170 is a foot plate replacing a frame at a lower end portion of a side surface of the vehicle body 100.

Further, the secondary lift wing floating bodies 350a and 350b are mounted while spreading a drawer type sliding door 190, and are inserted inside the vehicle body at a bottom floor of the vehicle body by the double acting hydraulic cylinder while being folded and collected to the center of the lift wing floating body from the left and right of the lift wing floating body, and by closing the sliding doors 190a and 190b, it is possible to mount and detach the secondary lift wing floating bodies 350a and 350b. In addition, the secondary wing floating bodies 350a and 350b are connected to a jet nozzle 397 by a compressor 396 to open a compressed air intake valve 393 to take in compressed air, and the compressed air is filled in the lift wing floating body.

The floating body is made with a drawer type sliding, and motors 385a and 385b and drawer type sliding supports 398a and 398b and installed in a sliding track to connect power, and when the power is turned on, as an electric current flows in a forward direction, the sliding supports 398a and 398b are extended and spread in a horizontal direction, and when the power is supplied to flow in a reverse direction, are folded in a horizontal direction.

Further, when the motor rotates in a forward direction, while the drawer type sliding support attached to the motor rotates 90 degrees in a horizontal direction, the secondary lift wing floating body is extend and spread while being spread in a drawer type sliding manner.

In addition, when the power is supplied to flow in a reverse direction, the drawer type sliding support attached to the motor is erected in a vertical direction, and the extended secondary lift wing floating bodies 350a and 350b are folded and released in a horizontal direction.

Further, the reason for using drawer type sliding supports is in that they act as supports for prevented the extended secondary lift wing floating bodies from being pushed back to be pushed to the center of the lift wing floating body due to the pressure of water when the secondary lift wing floating bodies are made to extend horizontally in the water.

Further, when predetermined driving force is generated according to the control of the manipulating panel 900, the double acting hydraulic cylinders 395a and 395b not only are extended to a lower side direction to a predetermined length in a state ere the lift wing floating body 400 is mounted inside the vehicle body 100 due to the linear reciprocating motion of the double acting hydraulic cylinders 395a and 395b, but also at the same time, extend the secondary lift wing floating bodies 350a and 350b to a pre-calculated distance in a horizontal direction using the drive of a motor 310b and the drawer type sliding supports 398a and 398b.

Here, in the case where the drawer type sliding supports 398a and 398b provided at the lift wing floating body 400 are laid horizontally by the driving of the motor, each of the drawer type sliding supports 398a and 398b are folded in a direction or extended in a horizontal direction.

In addition, compressed air takes in air using compressor 396 installed at an upper portion of the vehicle body and when the air is blown towards the inside or the lift wing floating body 400 from a jet nozzle 397 in the periphery of a lower side, an air film is generated inside the lift wing floating body made of a rubber tube material.

Further, the air trapped in the air film forms an air cushion with increased pressure.

Thus, when it reaches a point equal to the weight of the vehicle body, the vehicle body is made to float.

Further, a first is a small semicircular compressed air hole cover, which is an air discharge valves 394a and 394b.

Further, the compressed air is taken into the lift wing floating body, and escapes out of the vehicle body through the air discharge valves 394a and 394b from inside the lift wing floating body.

Further, as shown in FIG. 3A, an electromagnet is disposed on the left and right secondary front bumper 130 and secondary rear bumper 140 of the bottom floor of the vehicle body, and is lowered from the vehicle body side sill |panel|[smhwang1] 170 to the bottom surface, and the left and right permanent magnets 392a and 392b attached to the bottom floor of the floating body are fixed in close contact with each other.

In addition, when the vehicle body submerges, the compressed air in a tank of the lift wing floating body 400 escapes to the air discharge valve and the vehicle body becomes heavy and is led to be submerged.

Furthermore, compressed air inside the tank of the lift wing floating body 400 is emptied and the air discharge valves 394a and 394b are closed.

Further, when the vehicle body is lifted, compressed air is blown into the tank of the lift wing floating body 400 through the air intake valve 393 of the compressor 396 so that the compressed air fills the tank of the lift wing floating body 400, and thus, when wind is blown to the lift wing inside the lift wing floating body, a lifting force is generated by the wing, and the air discharge valves 394a and 394b are opened so that the compressed air escapes through the air discharge valve so all is always flowing.

In addition, a rubber tube oil tank is attached inside a cylinder by a piston to the diving control key 600, and the rubber tube oil tank is extended in a vertical direction by the pressure of oil 375, and when the oil 375 is pushed in by pressure of the piston, the rubber tube oil tank inside the lower cylinder tube is extended vertically and the oil tank is filled with the oil.

At this time, as the rubber tube is expanded and filled with oil, the volume of the vertical oil tank is increased and consequently is vertically erected.

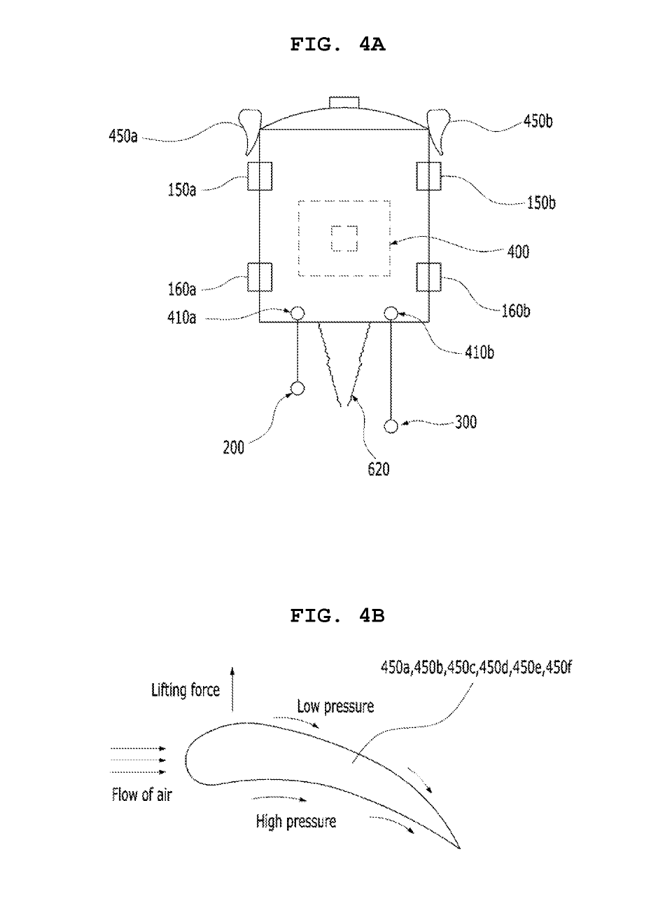

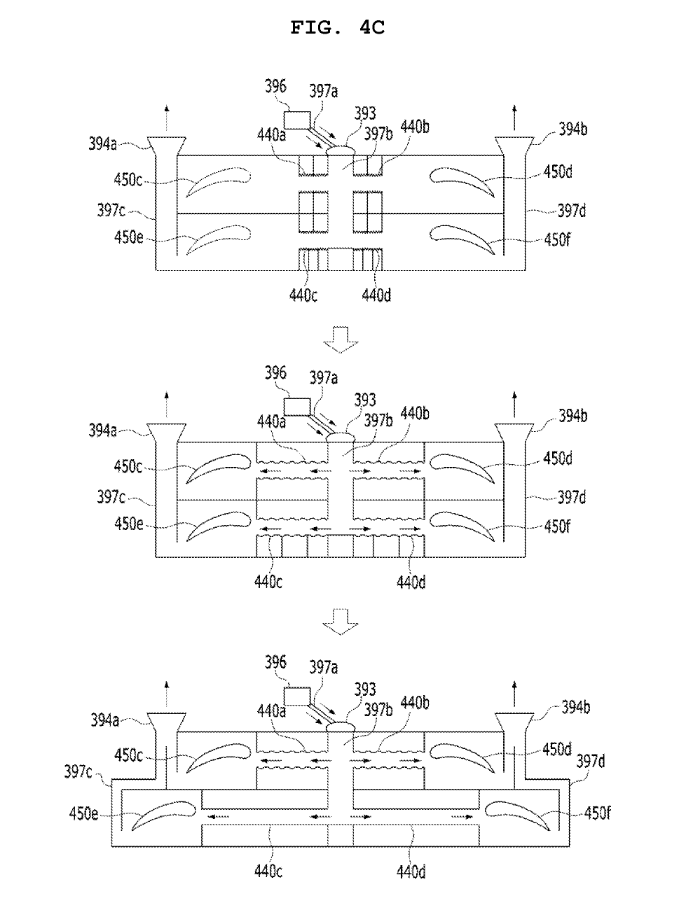

Further, as shown in FIGS. 4A and 4B, first wings 450a and 450b are mounted in the outer circumferential direction of the front bumper 110, that the streamlined wings generate a lifting force with the wind pressure according to speed. In addition, as shown in FIG. 4A, when pressure is generated by the wind generated due to the lift wings installed on the left and right of the front bumper due to the speed of the vehicle upon operation, a lifting force for lifting the vehicle body upwards is generated to lift the vehicle body upward.

To explain the principle of the lift, as illustrated as a cross section of the side of the lift wing, it is not horizontal but the front side is held at a certain angle (angle of reception).

When a wing without such angle of reception flows through the air, the air flow remains horizontal without any significant feature in the flow of air. However, when a wing with a slight angle of reception passes through the air, because the lower side of the wing is blocked with the wing, the flow of the air flows downward, and above the wing, that is, the upper surface of the wing becomes an air-free vacuum state.

Actually, because atmospheric pressure exists and the wing passes through the sky in the presence of air (same as flying in the floating body), the air at an upper side of the wing does not just flow as it is, but by atmospheric pressure and the air being made to be continuous, like how wind moves from high pressure to low pressure, the air at an upper side of the wing flows smoothly to the upper portion direction of the wing.

As a result, due to the continuous effect of flow at the top and bottom of the wing according to the change in the flow of all air changes of going down from the wing having an angle of reception, the overall flow of air is made to accelerate downward, and as the acceleration increase, the force increases, and if velocity is obtained through the thrust generated in the air through this, the lift wing will have a sufficient lifting force to fly.

Further, the wing delivers force to the air to break the flow of air, and the air reacts to that force to the wing, and by the Bernoulli theorem, the force of the air acts in a downward direction, to enable the lift wing to fly against gravity.

Meanwhile, the lift wing is attached and fixed at left and right side surfaces of the front bumper upon operation on land, and is extended at the left and right side surfaces of the front bumper upon operation on water for the streamlined wings to generate a lifting force due to the friction by high speed wind.

Further, when operated on water, the buoyancy is increased in the floating body and the vehicle body generates a lifting force to lighten the vehicle body.

Further, the wings extend outward from the left and right side surfaces of the front bumper to a form like that of an airplane wing, and have an angle of reception and a lifting force due to friction by high speed wind is generated. When operated on the ground, the wings extended from the side surfaces are folded to the left and right side surfaces and operated on the land and the wings are only spread when operated on water to gain lift. When a cable is wound on the wing, it is folded to the left and right side surfaces of the front bumper, and when the cable is released, it is made into a form extending outward from the left and right side surfaces of the front bumper.

Further, the air at the upper part of the streamlined lift wing goes fast, while the air at the lower part of the streamlined lift wing is slow and is lagged to move slowly.

Further, the lower side end portion of the wing is curved, causing the air to collide with it, which slows down the air flow and lags it, thus raising the air pressure naturally.

Further, a downhill path like a mountain is formed at the upper part of the wing, and the flow of air is accelerated, thus the air pressure is lowered.

In addition, the air lifts the lift wing according to the property of moving from a high pressure to a low pressure, whereby the second and third wings generate lifting force in the floating body to lift the floating body upward, thereby increasing buoyancy, and the first wings 450a and 450b receive lifting force from the left and right side surfaces of the front bumper of the vehicle body to allow the vehicle body to be lifted.

Further, lifting force refers to upward force perpendicular to the proceeding direction of an object moving horizontally in a fluid body due to a force of lifting.

That is, the lifting force is generated perpendicular to the flow and can occur regardless of the direction of gravity.

Further, as shown in FIG. 4B, the cross section of the lift wings 450a, 450b, 450c, 450d, 450e, and 450f is formed to have a form minimizing the resistance from the fluid with respect to velocity, that is, formed as a streamline, wherein the flow of air is higher at the upper side of the wings than at the lower side of the wings, resulting in high pressure.

Therefore, since the upper surface of the wing is low in pressure, the flow rate of the air is increased, and on the contrary, the pressure of the lower surface is increased and the flow rate of the air is lowered.

Accordingly, a lifting force is generated through the pressure difference between the upper surface and the lower surface of the wing, thereby generating a speed difference between the upper surface and the lower surface of the wing.

In addition, if the lifting force is caused by the pressure difference between the upper surface and lower surface of the wing, the difference in pressure between the upper surface and lower surface of the wing is caused by the asymmetrical shape of the wing and the inclined shape toward the back (angle of reception).

For example, if there is a flat plate parallel to the flow of air, and the back of the plate is bent like a downhill form, the air flows along the flat plate and then bends downward from the flow in the same manner at the point where the flat plate is bent downward.

In addition, this bent part becomes the innermost side in the curved flow, and the pressure is lowered like the center of the vortex.

Further, as shown in FIG. 4C, when the compressed air 490 is taken in by opening the compressed air inlet valve 393, connected with a jet nozzle 397a by the compressor 396, the lift wing floating body is filled with compressed air with a jet nozzle 397b attached therein.

Then, the compressed air is blown through the bellows rubber hoses 440a, 440b, 440c, and 440d attached to the floating body. At this time, the compressed air 490 flows rapidly through the wings and is discharged to the jet nozzles 397c and 397d, and is discharged to the outside of the floating body through the air discharge valves (fists) 394a and 394b. In this process, a lifting force is generated to be applied to the wings to fly in the floating body, and the floating body can be lifted up.

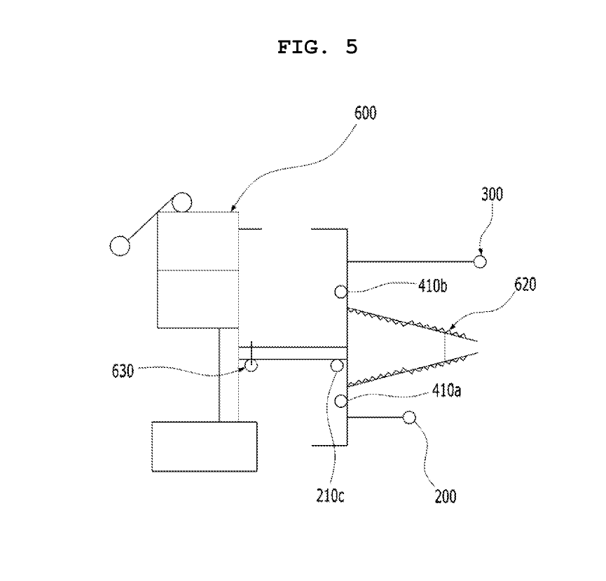

As shown in FIG. 5, when oil stored inside the oil tank installed vertically by the piston is taken in and sent to flow into a rear end horizontal oil tank tail 620, a rubber band attached to the inside or a rubber tube is stretched in elasticity and extended horizontally, increasing the volume of the rubber tube horizontal oil tank tail increases and becomes horizontal.

Accordingly, the vertical oil tank 610 is converted into a horizontal oil tank tail 620 increases in volume and oppositely, the horizontal oil tank tail 620 is converted into a vertical oil tank 610 and becomes heavy to serve to make the oil tank erect in a top to bottom direction and forms a buoyant central body. As a result, when operated on water, it is possible to change directions with the horizontal tank tail 620, which is the steering key, and the submerging and rising of the horizontal oil tank tail is adjusted.

Therefore, the horizontal oil tank tail 620 adjusts direction to the left and right by an electric motor to serve as the steering key.

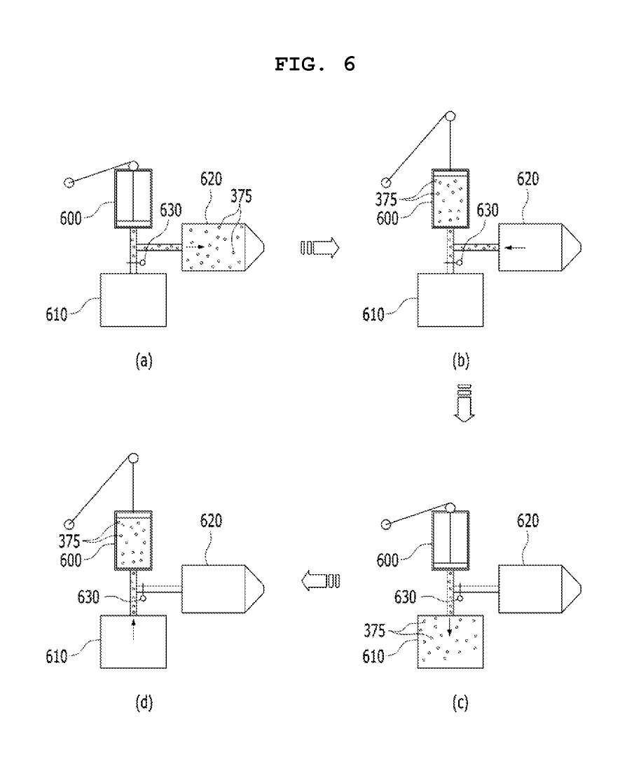

In addition, the structure and operation principle of the diving control key will be described in detail with reference to FIG. 6.

The diving control key 600 adjusts the submerging or rising above the water by having the vertical oil tank 610 which is attached next to the lift wing floating body 400 and the horizontal oil tank tail 620 which is attached to the rear end of the lift wing floating body 400 alternate between submerging and rising, while using the diving control key 600 which is pulled or pushed for contraction and relaxation to put in and take out oil 375. The diving control key 600 is provided with a switching valve 630 for putting in and taking out the oil 375 and has an outlet in the vertical direction of the bottom floor vertical oil tank of the vehicle body and in the horizontal direction of the horizontal oil tank tail pipe 620 of the rear end vehicle body, and the vertical direction of the vertical oil tank 610 and the horizontal direction of the rear end horizontal oil tank tail 620 are converted.

When submerging, the switching valve 630 of the diving control key 600 closes the tail of the rear end horizontal oil tank tail in the horizontal direction and when the vertical oil tank positioned at the bottom floor is opened in the vertical direction, due to the diving control key (oil pump piston), oil 375 is discharged to the vertical oil tank, and the center of gravity of the vehicle body is concentrated downward and is submerged.

When rising above the water, the switch valve 630 of the diving control key 600 closes the vertical oil tank in the vertical direction and opens the rear end horizontal oil tank tai in the horizontal direction, and due to the diving control key (oil pump piston), oil 375 is discharged to the rear end horizontal oil tank, and the center of gravity of the vehicle body is dispersed to the rear end to float on the water. The oil tank is made of a rubber tube and it can contain oil and does not flow down.

The vertical oil tank is elastically stretched or shrunk in volume as the oil is filled or emptied.

When rising above the water, because the rear end horizontal oil tank tail is positioned between the rear end right and left piston propellants 200 and 300 and rotates on the water at the rear end, the volume of the vehicle body is increased to increase the buoyancy.

The principle of operation of the diving control key 600 is as follows. First, the vertical oil tank is closed by using the switching valve of the diving control key (oil pump piston) and when the diving control key (water pump piston) is pulled back in a state where the rear end horizontal oil tank tail is left open, the rear end horizontal oil tank tail is closed and the vertical oil tank is left open due to absorptivity.

Then, when the diving control key 600 is pushed forward to apply pressure, the oil in the cylinder is injected into the vertical oil tank 610 and is filled, so that the center of gravity of the vehicle body is concentrated downward and becomes heavy and is made to submerge.

The principle of operation when rising above the water is as follows. The rear end horizontal oil tank tail is closed by using the switching valve of the diving control key (oil pump piston) and when the diving control key (water pump piston) is pulled back in a state where the vertical oil tank is left open, the oil of the vertical oil tank enters the piston of the cylinder and at the same time, using the switching valve, the vertical oil tank closed and resultantly the rear end horizontal oil tank tail is opened due to absorptivity of water.

Then, when the diving control key (oil pump piston) is pushed forward and pressure is applied, the oil in the cylinder is injected into the horizontal oil tank tail and filled, so that the center of gravity of the vehicle body is dispersed to the rear, thereby becoming lighter to make it rise above the water.

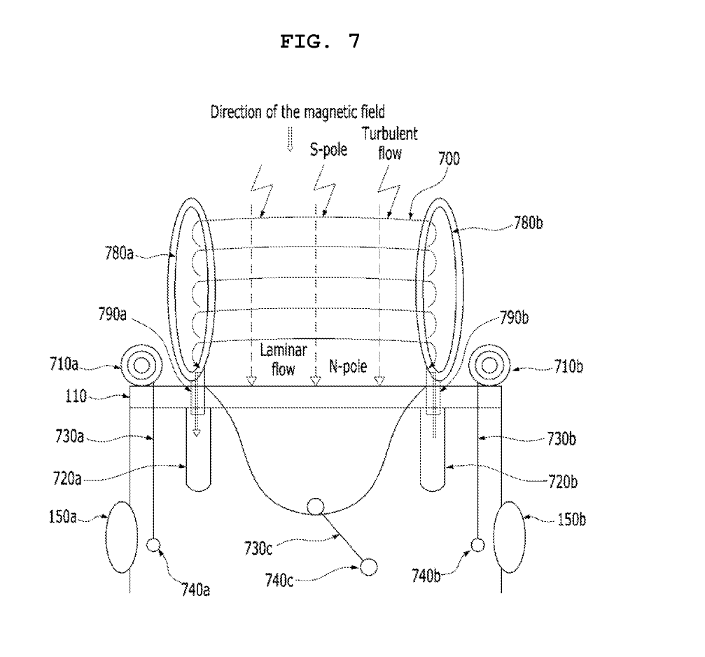

Further, as shown in FIG. 7, the front wing opening circular coil 700 includes a motor 740a that generates a predetermined driving force under the control of the manipulation panel.

Here, it may be noticed that a current flows upward along a coil-wound direction. Since a line of magnetic force flows to left, a left side is N-pole and a right side is S-pole. Also, since a magnetic field (around a magnet) flows from N-pole into S-pole at the outside of the coil, a loop-current magnetic field is formed. Accordingly, the turbulent flow becomes a conductor to be converted into a laminar flow.

It is a magnetic field that is created when a wire is bent in a circular shape, a wire is wound like a coil, and a current flows in the circular wire.

The magnetic field at the center of the circular current is proportional to the intensity of the current and inversely proportional to the radius of the circular conductor. The direction of the magnetic field inside a solenoid is the direction that the thumb points when you spread the thumb of your right hand and wrap the direction of the current with the remaining four fingers. When a substance such as iron (iron core) is placed in the solenoid, the magnetic field becomes strong. The magnetic poles are defined such that the North Pole is where the water flows out, and the South Pole is where the water flows in. The electromagnetic induction phenomenon is confirmed through the coil rotating in the magnetic field, and the force of the current flowing in the magnetic field is measured. Here, the circular coil 700 of the front wing rod is configured to have an electric circular coil, electric heaters 710a and 710b, electric heater motors 740a, 740b, 740c, a temperature regulator, tourmalines 780a and 780b, and cables 730a, 730b, 730c.

The electric heater 710a and 710b (an electric bar which is put into water to boil the water), which is mounted in an elliptical form does not cause an electric shock but has the function of adjusting temperature. The electric heater is an elliptical bar which increases temperature of water by being put in the water and laminarizes a turbulent flow of the water by convection of the water. The convection refers to the transfer of heat by a flow of fluid which is generated due difference of temperature. Waves which are partially heated become light to come up toward a top by buoyancy (the force applied to an object in an opposite direction in a vertical direction to gravity in fluid), and upper cold waves move down to absorb heat of the electric heaters 710a and 710b. In such a manner, as the waves flow up and down, the water is laminarized.

Whether not the electric heaters 710a and 710b are operating may be checked by a white plume phenomenon caused due to joining of the electric heaters 710a and 710b and cold waves (i.e., a phenomenon that drops of water looking like white smoke are generated). The convection generated by the electric heaters 710a and 710b installed at the left and right of the front bumper 110 may make the turbulent flow changed into the laminar flow. This may result in reduction of speed and friction of water, thereby the electric heater 710a and 710b raises the temperature of the surrounding water to generated heat in an up-down direction. The tourmalines 780a and 780b which are in the form of a circular belt and mounted in the front wing rod circular coil 700 continuously generates a current, and when the current comes in contact with waves, electricity may be generated so as to instantaneously decompose water. The tourmaline is an ore which is composed of a plus electrode and a minus electrode. When the tourmaline is put into water for a predetermined time (for about 5 minutes), the water is alkalized. By using the property of generating electricity, the tourmaline makes a current flow on waves to laminarize the turbulent flow.

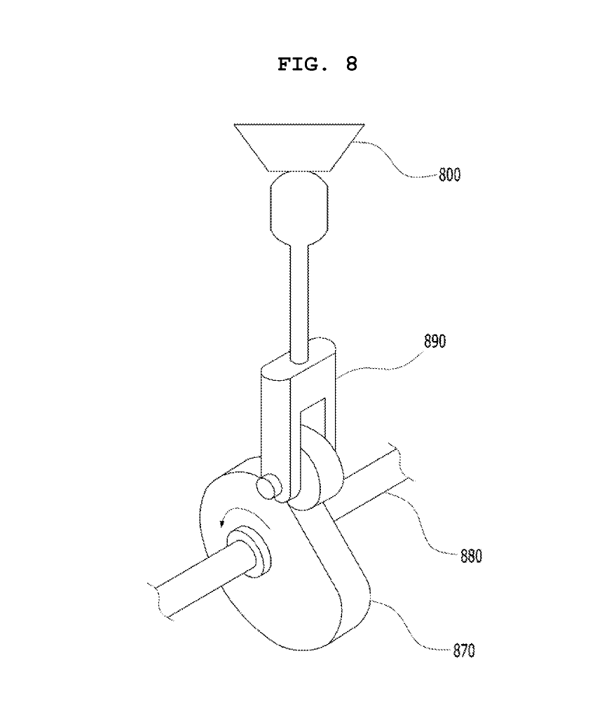

Further, as shown in FIG. 8, the secondary piston propellant 800 relates to a cam shaft 880 of a lower side rotating as a driven section 890 moves up and down, and FIG. 8 illustrates the operation of the secondary piston propellant 800 mounted on an elliptical disc cam 870 and driven section 890.

At this time, the energy source is a camshaft 880 that is mainly used in an internal combustion engine such as an intake and exhaust valve of an automobile engine, and in the case of the camshaft 880, mutual conversion of rotary motion and linear motion that are horizontal to each other is performed. The rotary motion of the elliptical disc cam 870 and the camshaft 880 of the electric motor is converted into a vertical motion of the driven section 890 and is delivered to the crankshaft of the secondary piston propellant 800. A device having a mechanical structure that changes the horizontal rotary motion into a vertical reciprocating motion is a cam (a device that turns the rotational motion of a wheel into a reciprocating motion). When the elliptical disc cam 870 (wheel) rotates, the driven section 890 abutting the elliptical disc cam 870 moves up and down.

In addition, at the time of forward movement, the secondary piston propellant 800 is actuated, and the secondary piston propellant 800 is stopped at the time of stopping, and protruded from the rear end to serve as a brake due to high speed wind friction. During land operation, the cable 315 is wound by an electric motor and the secondary piston propellant is raised from the bottom to the secondary piston holder 810 to facilitate on land operation.

What is claimed is:

1. An amphibious vehicle comprising:
a pair of piston propellants 200 and 300 mounted to a rear bumper 120 of a vehicle body 100, operated in an alternating motion with respect to each other so as to push back water of a water surface while a scotch yoke motor 210 is converted to a reciprocating motion to move in a direction from an upper part to a lower part upon rotation in a left or right direction;
a lift wing floating body 400 mounted between a front wheel 150 and a rear wheel 160 of the vehicle body 100 inside the vehicle body 100, which is extended in a front bumper 110 and a rear bumper 120 direction to cover the front wheel 150 and the rear wheel 160;
a secondary piston propellant 800 which adjusts a moving direction with a proceeding direction and a brake direction of the vehicle body 100 according to a control of a user; and
a manipulating panel 900 positioned inside the vehicle body 100 and mounted on a bottom surface of the front bumper 110 of the vehicle body 100, which selectively controls an operation of a front wing rod circular coil 700 extended to a front direction according to a manipulation of the user.

2. The amphibious vehicle of claim 1, wherein the pair of piston propellants 200 and 300 are operated in an alternating motion with respect to each other so as to push back water of a water surface, through a first motor 21 which generates a predetermined driving force according to a control of the manipulating panel 900 installed in the vehicle body 100, and first and second crankshafts 270a, 270b, 270c and 270d which move in a rotating motion in a specific direction by the drive of the first motor 21.

3. The amphibious vehicle of claim 1, wherein the lift wing floating body 400 is configured to have,
a main lift wing floating body 400a wherein double acting hydraulic cylinders 395a and 395b that generate a predetermined driving force according to a control of the manipulating panel 900 in a state mounted inside a side sill panel 170 of the vehicle body 100 are extended to a predetermined length from top to bottom; and
secondary lift wing floating bodies 350a and 350b installed inside the lift wing floating body 400 and which extends in a horizontal direction to a predetermined distance by the drive of drawer type sliding supports 398a and 398b and a motor 310a.

4. The amphibious vehicle of claim 1, further comprising,
secondary lift wing floating bodies 350a and 350b installed the lift wing floating body 400 and which extends the lift wing floating body 400 to a predetermined distance by a drive of a third motor 310b; and
a plurality of drawer type sliding supports 398a and 398b which moves the lift wing floating body 400 horizontally to a secondary front bumper 130 and secondary rear bumper 140 of the vehicle body 100 in the case where a first cable is released.

5. The amphibious vehicle of claim 1, wherein
the secondary piston propellant 800 is installed between the plurality of drawer type sliding supports 398a and 398b, to be mounted at a lower end of a secondary rear bumper 140 positioned between, a plurality of electric motors 385a and 385b that folds each of the drawer type sliding supports 398a and 398b in a vertical direction or extends each of the drawer type sliding supports 398a and 398b in a horizontal direction, and the pair of piston propellants 200 and 300

6. The amphibious vehicle of claim 1, further comprising a diving control key 600 which adjusts the vehicle body 100 to submerge or rise above water when pulled or pushed for contraction and relaxation to put in and take out oil 375, by having a vertical oil tank 610 which is attached next to the lift wing floating body 400 and a horizontal oil tank tail 620 which is attached to a rear end of the lift wing floating body 400 alternate between submerging and rising.
